(19) United States
(12) Patent Application Publication
(10) Pub. No.: US 2022/0067556 A1
(43) Pub. Date: Mar. 3, 2022

(54) TECHNIQUES FOR CONTROLLING AUTONOMOUS VIRTUAL AGENTS

(71) Applicant: X Development LLC, Mountain View, CA (US)

(72) Inventors: Philip E. Watson, Felton, CA (US); Christian Ervin, Burlingame, CA (US)

(21) Appl. No.: 17/002,681

(22) Filed: Aug. 25, 2020

(51) Int. Cl. G06N 5/04

(52) U.S. Cl. CPC G06N 5/043

(57) ABSTRACT

Techniques for controlling virtual agents are provided. In some embodiments that control a first virtual agent, a computing device senses an environment, wherein the environment includes one or more environmental states and a group of other virtual agents. The computing device determines a goal of the group of other virtual agents. The computing device determines whether the first virtual agent should affiliate with the group of other virtual agents. In response to determining that the first virtual agent should affiliate with the group of other virtual agents, the computing device changes a goal of the first virtual agent based on the goal of the group of other virtual agents.

### TECHNICAL FIELD

This disclosure relates generally to virtual agents, and in particular but not exclusively, relates to controlling autonomous virtual agents.

### BACKGROUND

Realistic human behavior, and particularly empathy and prediction of the likely behaviors of others, is difficult to achieve in computer simulations of groups. Agent-based simulation in which the actions and responses of individuals or characters are determined by heterogeneous blocks of code, are the leading approach to predicting and portraying the activities of large collectives of people. These techniques can be used for many purposes, including but not limited to controlling autonomous characters within video games or other virtual environments.

### SUMMARY OF INVENTION

In some embodiments, a computer-implemented method of controlling a first virtual agent is provided. A computing device senses an environment, wherein the environment includes one or more environmental states and a group of other virtual agents. The computing device determines a goal of the group of other virtual agents. The computing device determines whether the first virtual agent should affiliate with the group of other virtual agents. In response to determining that the first virtual agent should affiliate with the group of other virtual agents, a goal of the first virtual agent is changed based on the goal of the group of other virtual agents.

In some embodiments, a non-transitory computer-readable medium is provided. The computer-readable medium has logic stored thereon that, in response to execution by one or more processors of a computing device, cause the computing device to perform actions comprising: sensing, by the computing device, an environment, wherein the environment includes one or more environmental states and a group of other virtual agents; determining, by the computing device, a goal of the group of other virtual agents; determining, by the computing device, whether the first virtual agent should affiliate with the group of other virtual agents; and in response to determining that the first virtual agent should affiliate with the group of other virtual agents, changing a goal of the first virtual agent based on the goal of the group of other virtual agents.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a block diagram that illustrates a non-limiting example embodiment of a system that includes virtual agents according to various aspects of the present disclosure.

FIG. 2A—FIG. 2C are schematic diagrams that illustrate a non-limiting example embodiment of the operation of an example virtual agent according to various aspects of the present disclosure.

FIG. 3 is a block diagram that illustrates some components of a non-limiting example embodiment of a computing device configured to provide a virtual agent according to various aspects of the present disclosure.

FIG. 4A—FIG. 4B are a flowchart that illustrates a non-limiting example embodiment of a method of controlling a first virtual agent according to various aspects of the present disclosure.

FIG. 5 is a block diagram that illustrates a non-limiting example embodiment of a computing device appropriate for use as a computing device with embodiments of the present disclosure.

### DETAILED DESCRIPTION

In the present disclosure, techniques are provided that help improve the realism of the behavior of virtual agents by inferring models of the likely behavior of other agents, inferring goals of groups of other agents, and choosing whether or not to have a virtual agent affiliate with a group of other virtual agents based on the inferred group goals.

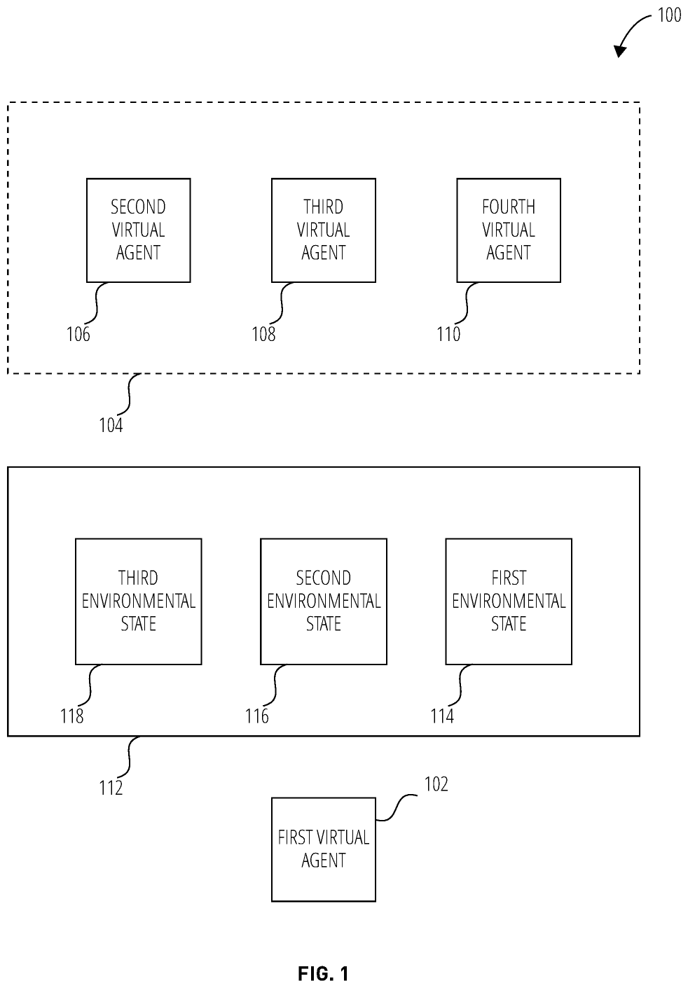

FIG. 1 is a block diagram that illustrates a non-limiting example embodiment of a system that includes virtual agents according to various aspects of the present disclosure.

As shown, the system 100 includes a plurality of virtual agents. A virtual agent is a representation of an entity that observes its environment, executes logic to process its observations of its environment, and perform actions based on the output of the processing of its observations. Typically, a virtual agent performs these operations, logic, and actions under control of one or more computing devices. At some points in the present disclosure, the virtual agent may be described as an entity that itself performs observations, makes decisions, and takes actions based thereon. One will recognize that this description is a simplification made for the sake of clarity. In some actual embodiments, the goals and logic of each virtual agent may be represented by information stored in a data structure stored on a computer-readable medium, and the observations, decisions, and actions may be performed by a computing device configured to simulate operation of the virtual agent as represented by the stored information.

One common use for virtual agents is to represent artificially intelligent, computer-controlled characters (non-player characters, or NPCs) within a virtual environment such as a video game, a virtual reality environment, a chat bot, or other virtual environments. By using autonomous virtual agents to control such entities, a greater degree of realism and interactivity can be achieved than if the entities are programmed with simple rulesets. For example, compared to particle-based techniques that implement entities with simple rulesets, virtual agents can be heterogenous. That is, different virtual agents in a group can be configured with different “personalities,” such that different virtual agents configured with different personalities may react differently to the same observed environmental states. This provides a more realistic simulation, at least in that actual people would also react differently to the same observed environmental states based on their personalities.

In FIG. 1, the system 100 is illustrated from the point of view of a first virtual agent 102 in order to describe the actions that take place with respect to the first virtual agent 102. The system 100 also includes a plurality of other virtual agents 104, including a second virtual agent 106, a third virtual agent 108, and a fourth virtual agent 110.

Each of the virtual agents within the system 100 are controlled to autonomously take actions that affect one or more environmental states 112. As shown, the system 100 includes a first environmental state 114, a second environmental state 116, and a third environmental state 118, though in some embodiments, more or fewer environmental states 112 may be present. Further, in some embodiments, the environmental states 112 and the virtual agents may not be strictly separate as illustrated, but instead, aspects of the virtual agents themselves may be observable as environmental states 112.

In some embodiments, environmental states 112 may be any type of computer-detectable state relevant to operation of a virtual agent. For example, environmental states 112 may include the location and condition of various objects in the environment, including but not limited to barriers such as walls, items consumable by the virtual agent, tools usable by the virtual agent, avatars of other virtual agents 104, and the avatar of the first virtual agent 102. As another example, environmental states 112 may include conditions at locations in the environment, including but not limited to weather, time of day, or lighting conditions. As yet another example, environmental states 112 may include intangible conditions, including but not limited to real-world or virtual economic conditions (including but not limited to commodity prices, account balances, and economic benchmarks), infection rates, social status, and numbers of other virtual agents 104 under control of the first virtual agent 102.

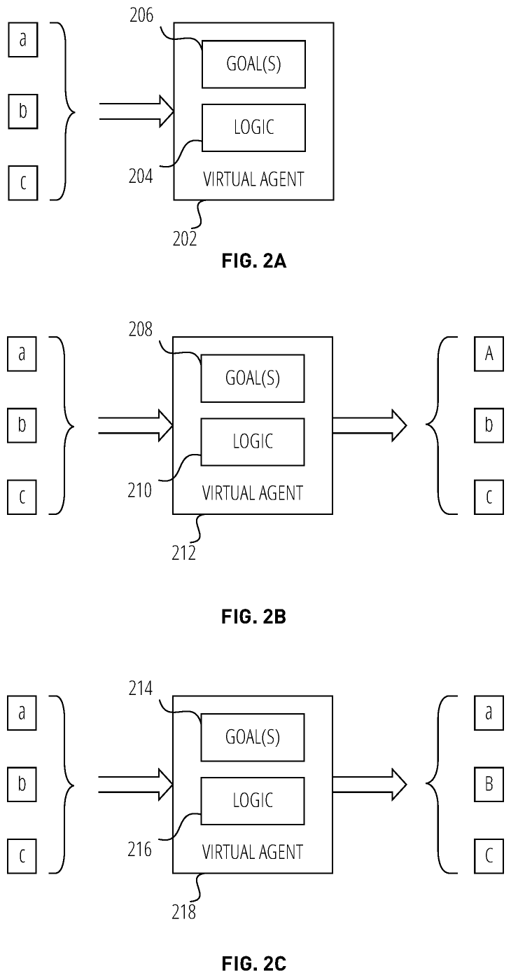

FIG. 2A—FIG. 2C are schematic diagrams that illustrate a non-limiting example embodiment of the operation of an example virtual agent according to various aspects of the present disclosure. FIG. 2A—FIG. 2C are vastly simplified versions of many embodiments of the present disclosure, but nevertheless help to provide context for the remainder of the discussion herein.

In each of FIG. 2A—FIG. 2C, a set of environmental states at a first time are illustrated on the left side of the drawing. As shown, the set of environmental states at the first time are a first environmental state (“a”), a second environmental state (“b”), and a third environmental state (“c”). These environmental states are illustrative only, and may stand in for any type of environmental state having any type of value. As some non-limiting examples, each environmental state may be a location of an object to be manipulated by the virtual agent 202, an available resource that may be utilized by the virtual agent 202, a location at which the virtual agent 202 may locate itself or an avatar which it controls, a piece of information that can be consumed by the virtual agent 202, or an aspect of another virtual agent within the environment of the virtual agent 202.

As shown in FIG. 2A, the virtual agent 202 observes the environmental states. Thereafter, logic 204 of the virtual agent 202 processes the environmental states to determine an action to take. In some embodiments, the action determined by the logic 204 may be based on one or more configurable goal(s) 206 of the virtual agent 202.

In some embodiments, the logic 204 may simulate effects on the environmental states of various possible actions that can be performed by the virtual agent 202, and may compare those simulated effects to the goal(s) 208 of the virtual agent 202. If the effects of one or more of the simulated actions cause the environmental states to be more in compliance with the goal(s) 208 of the virtual agent 202, then the logic 204 will cause virtual agent 202 to perform the one or more actions.

FIG. 2B shows one non-limiting example of such processing. As shown, the virtual agent 212 has observed environmental states a, b, and c. The logic 210 of virtual agent 212 simulates various actions that could be taken that may affect environmental states a, b, and c, and compares the results to goal(s) 208 of the virtual agent 212. As a result of the comparison, the logic 210 determines that the goal(s) 208 would be best served by performing an action that would change the environmental states from having the value “a” to having the value “A.” Accordingly, the logic 210 causes the virtual agent 212 to perform the corresponding action, and the environmental states are changed to “A,” “b,” and “c.”

FIG. 2C shows another non-limiting example of such processing. Starting from the same environmental states a, b, and c, the virtual agent 218 comes to a different result, taking actions that cause the environmental states to be “a,” “B,” and “C” due to its different logic 216 and/or its different goal(s) 214.

FIG. 2A—FIG. 2C are naturally a very simple example of operation of virtual agents. More complex examples may include predicting the results of a sequence of actions before the logic causes any particular virtual agent to perform an action. More complex examples may also include predicting one or more actions to be taken by other virtual agents, and choosing an action for a given virtual agent based on the predicted actions of the other virtual agents in addition to the detected environmental states.

By using these more complex analyses to control multiple virtual agents, the virtual agents may begin to exhibit emergent behavior. For example, if multiple virtual agents have the same or similar goal(s), then those virtual agents may work together as a group in order to accomplish the goal(s). Trivially, if a goal of the virtual agents is to move a collection of material from a first location to a second location, the virtual agents will each move the material from the first location to the second location, thereby helping each other accomplish the goal.

More complex behaviors may arise as the timeline for predictions extends and the joint understanding of goals across virtual agents increases. For example, a first virtual agent and a second virtual agent may both have a goal of moving an avatar associated with each virtual agent from a first area to a second area through a bottleneck (such as a door, a hallway, etc.). The first virtual agent may determine that the second virtual agent also has a goal to move to the second area and will have to pass through the bottleneck, and may further determine that both the first virtual agent and the second virtual agent will get stuck in the bottleneck if both continue on their planned courses. The first virtual agent may make a prediction regarding how the second virtual agent will react to this situation, and may make a decision to alter the course of the avatar of the first virtual agent in order to avoid conflict with the path of the avatar of the second virtual agent to avoid both virtual agents getting stuck. As such, the first virtual agent and the second virtual agent are working together to ensure that both can pass through the bottleneck to the second area without conflicting.

In some embodiments, as virtual agents are added to the system and the ability to predict outcomes of actions and the actions of other virtual agents improves, it becomes possible for group behavior to emerge. As virtual agents consider the predicted goals and behavior of other virtual agents, the virtual agents may act as groups in order to accomplish goal(s) that are infeasible or impossible to accomplish alone. In some embodiments, virtual agents may be explicitly organized into groups, for example, in embodiments wherein authoritative virtual agents have the ability to control actions of subordinate virtual agents in order to accomplish goals of the authoritative virtual agents. In such embodiments, it becomes important for a given virtual agent to be able to detect groups of other virtual agents, to identify goals of such groups, and to decide whether to affiliate with the groups by adopting the goals of the groups.

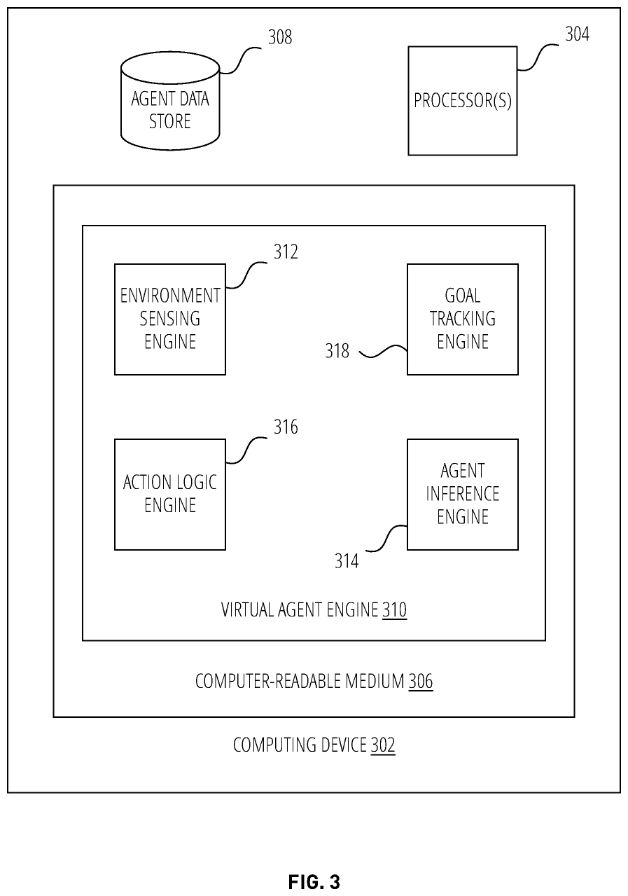

FIG. 3 is a block diagram that illustrates some components of a non-limiting example embodiment of a computing device configured to provide a virtual agent according to various aspects of the present disclosure. As with FIG. 1, the discussion below assumes that the computing device 302 is being used to simulate the first virtual agent 102 illustrated above for the sake of discussion, but this should not be seen as limiting: a computing device such as computing device 302 may be used to simulate any virtual agent in the system 100.

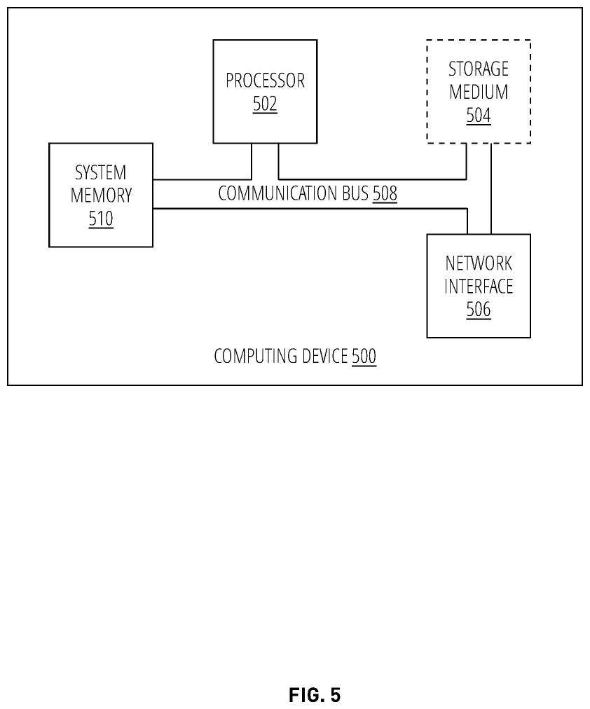

In some embodiments, any type of computing device (or combination of computing devices) may be used to provide one or more virtual agents, including but not limited to desktop computing devices, laptop computing devices, server computing devices, mobile computing devices (including but not limited to smartphones and tablet computing devices), computing devices participating in a cloud computing system, and any other type of computing device as illustrated in FIG. 5 and described below.

As shown, the computing device 302 includes one or more processor(s) 304, an agent data store 308, and a computer-readable medium 306. In some embodiments, the processor(s) 304 may include one or more of any type of general-purpose computer processor configured to execute instructions or other logic stored on the computer-readable medium 306. In some embodiments, the processor(s) 304 may include circuitry hard-wired to implement logic discussed below as embodied in an “engine,” including but not limited to an FPGA or an ASIC.

In some embodiments, the agent data store 308 is configured to store information about other virtual agents 104 as determined by the computing device 302 simulating the first virtual agent 102. In some embodiments, the agent data store 308 may also store information about the first virtual agent 102. As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

In some embodiments, the computer-readable medium 306 is a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage. As shown, the computer-readable medium 306 has stored thereon logic that, in response to execution by the processor(s) 304, causes the computing device 302 to provide a virtual agent engine 310, which may include an environment sensing engine 312, an agent inference engine 314, an action logic engine 316, and a goal tracking engine 318.

As used herein, “engine” refers to logic embodied in hardware or software instructions, which can be written in one or more programming languages, including but not limited to C, C++, C #, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

In some embodiments, the environment sensing engine 312 is configured to detect the environmental states 112. In some embodiments, the environmental states 112 are simulated by the computing device 302 as well, and the environment sensing engine 312 extracts the environmental states 112 from their simulation. In some embodiments, the environment sensing engine 312 may query one or more external data sources in order to detect the environmental states 112. In some embodiments, before providing an environmental state to be considered by a given virtual agent, the environment sensing engine 312 may determine whether the virtual agent would be able to sense the environmental state, or whether the environmental state would be somehow occluded or hidden from the virtual agent based on some condition of the virtual agent (e.g., the environmental state is a state of an object that is not within a line-of-sight of the virtual agent).

In some embodiments, the agent inference engine 314 is configured to determine internal configurations of other virtual agents 104, such that future actions of those virtual agents may be predicted in the context of determining how the first virtual agent 102 should react. In some embodiments, the agent inference engine 314 may predict logic or goals internal to the other virtual agents 104 based on observing the actions taken by the other virtual agents 104. In some embodiments, the agent inference engine 314 may have access to data storage that stores logic or goals of the other virtual agents 104, and may be capable of direct retrieving the logic or goals of the other virtual agents 104 for use in simulating the first virtual agent 102.

In some embodiments, the action logic engine 316 is configured to consider the environmental states 112 as reported by the environment sensing engine 312, predict the effect of one or more potential actions on the environmental states 112, compare the effects to one or more goals tracked by the goal tracking engine 318, and determine which action to take. In some embodiments, the action logic engine 316 is also configured to execute the action by implementing the changes on the environmental states 112. As mentioned above, the action logic engine 316 may be configured to simulate the cumulative effect of multiple consecutive actions, and to predict the actions of other virtual agents 104, as part of determining which action to execute.

In some embodiments, the goal tracking engine 318 is configured to create goals for the first virtual agent 102. The goals may be any suitable achievement in the context of the system 100, including but not limited to changing particular environmental states 112 from one state to another (including but not limited to moving objects from one location to another), obtaining a status for the first virtual agent 102 (including but not limited to gaining a level in a game, increasing a number of other virtual agents 104 subordinate to the first virtual agent 102, increasing a level of income for the first virtual agent 102, and increasing a score in a game for the first virtual agent 102), and so on. In some embodiments, the goal tracking engine 318 may create and prioritize more than one goal for the first virtual agent 102. That is, if multiple goals are being tracked for the first virtual agent 102 and a given simulated action may advance a first goal but not advance (or hurt) a second goal, the action logic engine 316 may use the prioritization of the goals established by the goal tracking engine 318 to decide whether to perform the given action. In some embodiments, goals may be divided into time frames, such as short-term goals and long term goals. In such embodiments, short-term goals and long-term goals may be prioritized separately, and an action that advances a short-term goal may be more likely to be chosen if it advances a long-term goal as well.

Further description of the functionality of each of these components is provided below.

In some embodiments, a separate virtual agent engine 310 may be instantiated for each virtual agent in the system 100. In some embodiments, a given virtual agent engine 310 may include more or fewer components than those illustrated in FIG. 3. For example, if a given virtual agent is not configured to infer and react to the logic and goals of other virtual agents, then the virtual agent engine 310 instantiated for the given virtual agent may not include the agent inference engine 314. In some embodiments, a given computing device 302 may execute several concurrent instantiations of the virtual agent engine 310 in order to concurrently simulate more than one virtual agent. In some embodiments, a separate computing device 302 may be provided for the virtual agent engine 310 for each virtual agent. In some embodiments, multiple computing devices may collaborate to provide a single virtual agent engine 310.

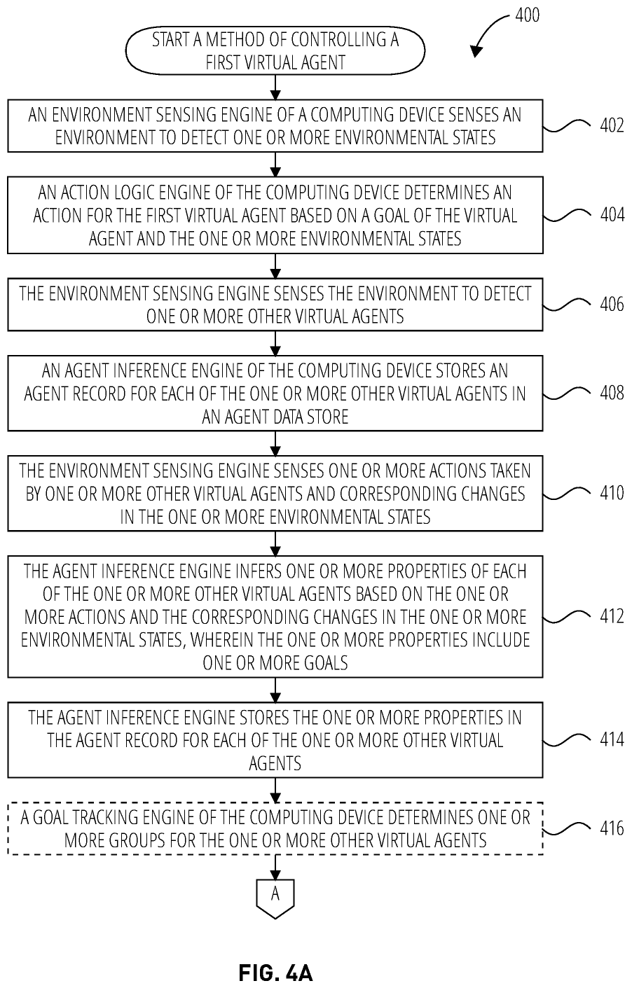

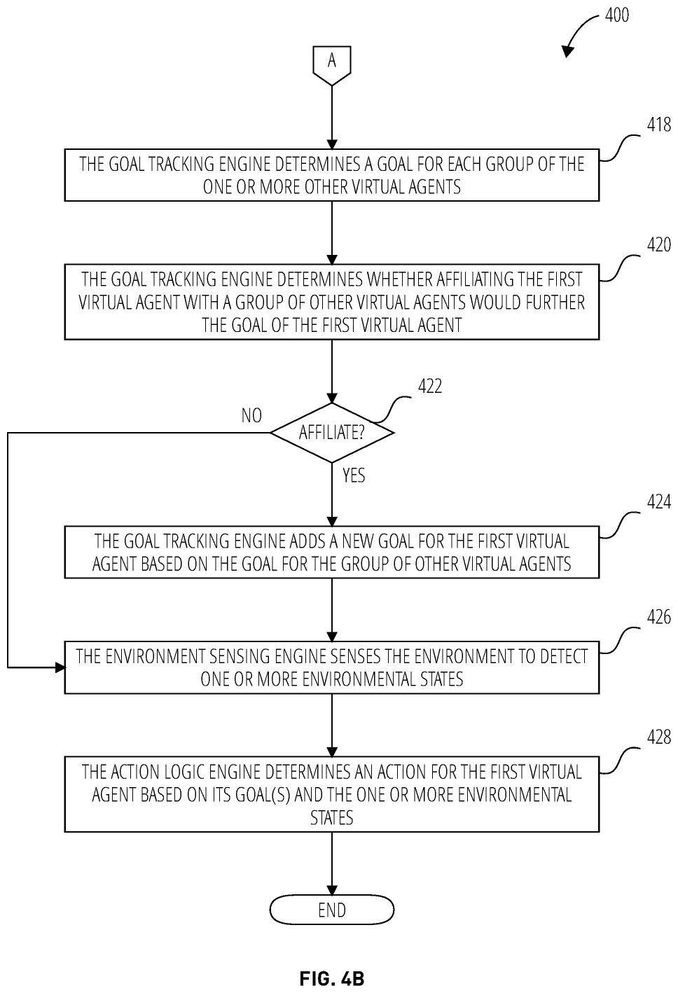

FIG. 4A—FIG. 4B are a flowchart that illustrates a non-limiting example embodiment of a method of controlling a first virtual agent according to various aspects of the present disclosure. In the method 400, the first virtual agent decides whether or not it would further its own goals if it were to affiliate with a group, and chooses whether or not to affiliate with the group based on the decision.

From a start block, the method 400 proceeds to block 402, where an environment sensing engine 312 of a computing device 302 senses an environment to detect one or more environmental states 112. As discussed above, the environment sensing engine 312 may use any suitable technique to detect the environmental states 112, including but not limited to receiving information about the environmental states 112 from an external data service, receiving signals from sensors that detect the environmental states 112, and directly determining the environmental states 112 from a simulation of the environmental states 112. In some embodiments, the environment sensing engine 312 detects environmental states 112 that are detectible by the first virtual agent 102. That is, if environmental states 112 are outside of the view or potential knowledge of the first virtual agent 102, such as being outside of a line of sight of an avatar controlled by the first virtual agent 102, the environment sensing engine 312 does not detect those environmental states 112.

At block 404, an action logic engine 316 of the computing device 302 determines an action for the first virtual agent 102 based on a goal of the virtual agent and the one or more environmental states 112. As discussed above, in some embodiments, the action logic engine 316 may simulate a result of one or more actions that could be taken by the first virtual agent 102 that affect the environmental states 112, may compare the results to the goal of the first virtual agent 102, and may choose an action based on which action (or sequence of actions) provides the most progress toward the goal. In some embodiments, the action logic engine 316 may consider progress toward more than one goal, and may use a prioritization of the goals provided by the goal tracking engine 318 to determine one or more goals towards which progress is most important. After choosing the action, the action logic engine 316 may cause the chosen action to be taken by the first virtual agent 102, and for corresponding changes to the environmental states 112 to be simulated. One will note that the simple actions described in block 402 and block 404 are similar to the simple actions illustrated in FIG. 2A—FIG. 2C and described above.

At block 406, the environment sensing engine 312 senses the environment to detect one or more other virtual agents 104. In some embodiments, this may involve the environment sensing engine 312 detecting an avatar or other entity controlled by each of the other virtual agents 104, and/or detecting one or more statuses of the entities. In some embodiments, the environment sensing engine 312 may detect the one or more other virtual agents 104 over time, such that a history of statuses of the other virtual agents 104 is detected.

At block 408, an agent inference engine 314 of the computing device 302 stores an agent record for each of the one or more other virtual agents 104 in an agent data store 308. The agent record may store an identification of the other virtual agent, and may store a history of statuses detected by the environment sensing engine 312 for the other virtual agent. In some embodiments, the agent record may also store other environmental states 112 detected at the same time as the detection of the other virtual agent.

At block 410, the environment sensing engine 312 senses one or more actions taken by one or more other virtual agents 104 and corresponding changes in the one or more environmental states 112. In some embodiments, the one or more actions may include one or more of a manipulation of one or more environmental states 112, a communication (including but not limited to a verbal, nonverbal, symbolic, text-based, and/or digital communication), and a transaction. In some embodiments, the one or more actions may be sensed as additional environmental states 112. In some embodiments, the one or more actions may themselves be inferred by comparing the environmental states 112 sensed before an action is taken to the environmental states 112 after the action is taken. In some embodiments, the environment sensing engine 312 may store the one or more actions along with the corresponding changes in the one or more environmental states 112 in the agent record associated with the other virtual agent that performed the actions.

At block 412, the agent inference engine 314 infers one or more properties of each of the one or more other virtual agents 104 based on the one or more actions and the corresponding changes in the one or more environmental states 112, wherein the one or more properties include one or more goals. In some embodiments, for a given other virtual agent, the agent inference engine 314 may be configured to predict environmental states 112 that are known by the other virtual agent (including, in some embodiments, by determining one or more environmental states 112 that are known to both the first virtual agent 102 and the other virtual agent by virtue of their lying within an overlapping field of view of both the first virtual agent 102 and the other virtual agent). The agent inference engine 314 may be configured to then simulate one or more potential actions that could be performed by the other virtual agent given the predicted environmental states 112 known by the other virtual agent, and may determine which of multiple possible goals each potential action could advance. The agent inference engine 314 may determine a goal that is advanced by the actual action that was observed, and may infer that goal to be a goal of the other virtual agent. In some embodiments, this inference may be strengthened or altered by observing further actions of the other virtual agent and determining whether they continue to align with either the same inferred goal or a different inferred goal.

In some embodiments, the agent inference engine 314 may also infer the logic that is executed by the other virtual agent, based on the environmental states 112 assumed to be visible to the other virtual agent and the action that was taken. In some embodiments, instead of inferring all of the logic executed by the other virtual agent from base principles, the agent inference engine 314 may be configured with two or more archetypes of logic for other virtual agents, and the agent inference engine 314 may infer which of the archetypes each of the other virtual agents 104 is most likely to embody. In some embodiments, the agent inference engine 314 may be configured to determine such archetypes by itself using a clustering technique or any other suitable technique, and may organize the other virtual agents 104 into its automatically determined archetypes.

At block 414, the agent inference engine 314 stores the one or more properties in the agent record for each of the one or more other virtual agents 104. In some embodiments, the agent inference engine 314 may revise the stored properties in the agent records over time as more information becomes available. For example, if further actions of another virtual agent are observed and the previously determined logic, goals, or archetypes for the other virtual agent do not explain the further actions, the agent inference engine 314 may update the determined logic, goals, or archetypes based on the additionally observed actions.

At optional block 416, a goal tracking engine 318 of the computing device 302 determines one or more groups for the one or more other virtual agents 104. In some embodiments, the one or more groups may be determined based on the goal tracking engine 318 finding that the other virtual agents 104 share the same goals, or at least share goals that are complimentary to each other. In some embodiments, the goal tracking engine 318 may determine one or more groups by observing environmental states 112 that include communication between other virtual agents 104, and finding that some of the other virtual agents 104 take action in response to commands some other of the other virtual agents 104. In some embodiments, other aspects of the other virtual agents 104 may be used to associate the other virtual agents 104 into groups, including but not limited to proximity of avatars controlled by the other virtual agents 104 or types of avatars controlled by the other virtual agents 104. Optional block 416 is illustrated as optional because, in some embodiments, all of the other virtual agents 104 may be assumed to be in a single group, and as such, the one or more groups do not need to be determined. The method 400 then advances to a continuation terminal (“terminal A”).

From terminal A (FIG. 4B), the method 400 proceeds to block 418, where the goal tracking engine 318 determines a goal for each group of the one or more other virtual agents 104. In some embodiments, the goal tracking engine 318 may determine the goal for each group by finding a goal for the individual other virtual agents 104 in the group that matches each other. In some embodiments, the goal tracking engine 318 may determine the goal for each group by finding a commonality between the goals for the individual other virtual agents 104 in the group. For example, the goal tracking engine 318 may identify goals of the other virtual agents 104 that are different from each other but are nonetheless each sub-goals of a larger goal. In this example, the goal tracking engine 318 may identify the larger goal as the goal of the group, even if none of the individual other virtual agents 104 are explicitly assigned the larger goal.

As a non-limiting illustrative example of this functionality, if a group is identified by virtue of avatars of the other virtual agents 104 being in proximity to each other, a second virtual agent 106 of the other virtual agents 104 has a goal of collecting lumber, a third virtual agent 108 of the other virtual agents 104 has a goal of attaching pieces of lumber together to make walls, and the fourth virtual agent 110 of the other virtual agents 104 has a goal of putting a roof on connected walls, then the goal tracking engine 318 may determine that the group has a larger goal of building a structure, even though none of the individual other virtual agents 104 have been identified as having an explicit goal of building a structure.

At block 420, the goal tracking engine 318 determines whether affiliating the first virtual agent 102 with a group of other virtual agents 104 would further the goal of the virtual agent. In some embodiments, the goal tracking engine 318 may compare the goal of the group of the other virtual agents 104, and determine whether it matches or is complimentary to a goal of the first virtual agent 102, even if such a goal is not the highest priority goal of the first virtual agent 102. In particular, in some embodiments, the goal tracking engine 318 may compare the goal of the group of the other virtual agents 104 to one or more long-term goals of the first virtual agent 102, and may look favorably upon affiliating with the group of other virtual agents 104 if taking actions to advance the goal of the group would advance one or more long-term goals of the first virtual agent 102, even if the actions would not advance one or more short-term goals of the first virtual agent 102. As another non-limiting illustrative example of this behavior, of the goal tracking engine 318 determined as discussed above that the group has a goal of building a structure, the goal tracking engine 318 may find that building a structure would further a long-term goal of the first virtual agent 102 of having a place to live, and so the goal tracking engine 318 may look favorably upon affiliating with the group even if short-term goals of the first virtual agent 102, such as consuming entertainment, would be deprioritized.

At decision block 422, a determination is made based on whether affiliating the first virtual agent 102 with a group of other virtual agents 104 would further the goal of the virtual agent. If affiliating would not further the goal of the virtual agent, then the result of decision block 422 is NO, and the method 400 proceeds to block 426. Otherwise, if affiliating would further the goal of the virtual agent, then the result of decision block 422 is YES, and the method 400 proceeds to block 424.

At block 424, the goal tracking engine 318 adds a new goal for the first virtual agent 102 based on the goal for the group of other virtual agents 104. In some embodiments, the new goal for the first virtual agent 102 may be the same as the goal of one or more of the other virtual agents 104 of the group, particularly if all of the goals of the other virtual agents 104 match each other. In some embodiments, the new goal for the first virtual agent 102 may be a sub-goal that helps further the goal of the group. To continue the non-limiting illustrative example from above, if the goal of the group is to construct a building, then the goal tracking engine 318 may add a goal that helps construct the building that is not yet already being worked on, such as painting or putting up drywall on walls framed by the third virtual agent 108. The method 400 then proceeds to block 426.

The above description implies that the goals for the first virtual agent 102 are changed in response to determining that the first virtual agent 102 should affiliate with the group of other virtual agents 104. In some embodiments, the goals for the first virtual agent 102 may also be changed in response to determining that the first virtual agent 102 should not affiliate with the group of other virtual agents 104. For example, the goal tracking engine 318 may determine that a long-term goal of the group of other virtual agents 104 is in conflict with a goal of the first virtual agent 102. In such a case, the goal tracking engine 318 may add a goal for the first virtual agent 102 that undermines or disrupts a near-term goal of the group of other virtual agents 104 upon determining that a long-term goal of the group of other virtual agents 104 is in conflict with a goal of the first virtual agent 102.

At block 426, the environment sensing engine 312 senses the environment to detect one or more environmental states 112. At block 428, the action logic engine 316 determines an action for the first virtual agent 102 based on its goal(s) and the one or more environmental states 112. The actions of block 426 and block 428 are similar to those discussed above with respect to block 402 and block 404, but use the new set of goals as determined by the goal tracking engine 318 (if a new goal was added at block 424).

The method 400 then proceeds to an end block and terminates. Though shown as terminating for ease of discussion, in some embodiments, the method 400 loops back to its beginning and continues to monitor the environmental states 112, determine actions, and adjust goals of the first virtual agent 102 in order to continue controlling the first virtual agent 102 over time.

In some embodiments, the method 400 is particularly powerful because the first virtual agent 102 does not need to explicitly be told the logic of any other virtual agent, does not need to explicitly be told the goals of any other virtual agent, does not need to explicitly be told the groups into which the other virtual agents are organized, and does not need to explicitly be told any collective goals of any such groups. Instead, the first virtual agent 102 uses inferences to attempt to understand the internal states of the other virtual agents and how those internal states may relate to individual and group goals, and may use its understanding of those internal states to decide whether or not to affiliate with the groups. Modeled after the real-world use of empathy, these techniques can lead to highly realistic simulation of actual agents that would naturally make such inferences based on their observations of the world and of other agents.

Naturally, though the method 400 describes the powerful technique of inferring logic, groups, and individual/group goals, in some embodiments, some of these pieces of information are provided directly to the first virtual agent 102 and do not need to be inferred. For example, in some embodiments, an organizational chart or other data structure available to the first virtual agent 102 may explicitly list one or more groups and/or one or more hierarchical structures into which the other virtual agents 104 are organized, thus relieving the first virtual agent 102 of the need to infer groups. In some embodiments, the first virtual agent 102 may use such information as a data point for its inferences, but may nevertheless conduct its inferences based on observed information, in case the logic of the other virtual agents 104 cause them to perform poorly as a group or as an organizational structure.

FIG. 5 is a block diagram that illustrates aspects of an exemplary computing device 500 appropriate for use as a computing device of the present disclosure. While multiple different types of computing devices were discussed above, the exemplary computing device 500 describes various elements that are common to many different types of computing devices. While FIG. 5 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Some embodiments of a computing device may be implemented in or may include an application-specific integrated circuit (ASIC), a field-programmable gate array (FPGA), or other customized device. Moreover, those of ordinary skill in the art and others will recognize that the computing device 500 may be any one of any number of currently available or yet to be developed devices.

In its most basic configuration, the computing device 500 includes at least one processor 502 and a system memory 510 connected by a communication bus 508. Depending on the exact configuration and type of device, the system memory 510 may be volatile or nonvolatile memory, such as read only memory (“ROM”), random access memory (“RAM”), EEPROM, flash memory, or similar memory technology. Those of ordinary skill in the art and others will recognize that system memory 510 typically stores data and/or program modules that are immediately accessible to and/or currently being operated on by the processor 502. In this regard, the processor 502 may serve as a computational center of the computing device 500 by supporting the execution of instructions.

As further illustrated in FIG. 5, the computing device 500 may include a network interface 506 comprising one or more components for communicating with other devices over a network. Embodiments of the present disclosure may access basic services that utilize the network interface 506 to perform communications using common network protocols. The network interface 506 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 506 illustrated in FIG. 5 may represent one or more wireless interfaces or physical communication interfaces described and illustrated above with respect to particular components of the computing device 500.

In the exemplary embodiment depicted in FIG. 5, the computing device 500 also includes a storage medium 504. However, services may be accessed using a computing device that does not include means for persisting data to a local storage medium. Therefore, the storage medium 504 depicted in FIG. 5 is represented with a dashed line to indicate that the storage medium 504 is optional. In any event, the storage medium 504 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 502, system memory 510, communication bus 508, storage medium 504, and network interface 506 are known and commercially available. For ease of illustration and because it is not important for an understanding of the claimed subject matter, FIG. 5 does not show some of the typical components of many computing devices. In this regard, the computing device 500 may include input devices, such as a keyboard, keypad, mouse, microphone, touch input device, touch screen, tablet, and/or the like. Such input devices may be coupled to the computing device 500 by wired or wireless connections including RF, infrared, serial, parallel, Bluetooth, Bluetooth low energy, USB, or other suitable connections protocols using wireless or physical connections. Similarly, the computing device 500 may also include output devices such as a display, speakers, printer, etc. Since these devices are well known in the art, they are not illustrated or described further herein.

For ease of discussion, the above description primarily relates to virtual agents that represent non-player characters in a video game, a virtual reality environment, a chat bot, or other virtual environments. These examples of virtual agents should not be seen as limiting, and in other embodiments, virtual agents may be used for other reasons. In some embodiments, one or more virtual agents within the system 100 may simulate or represent a human and be used to predict human behavior, such that the techniques above can be used to predict and influence behavior of groups of humans. That is, with the use of virtual agents to simulate the behavior of actual humans, the effect of changes to the environment on the virtual agents can be simulated in order to determine how actual humans would react to similar changes.

Such techniques of simulating human reactions to environmental changes have numerous uses. As one non-limiting example, such techniques may be used for architecture and engineering design to simulate how humans will realistically interact with a built environment such as a building or a community in order to improve the design of the built environments (e.g., to improve traffic flow, to improve efficient completion of tasks within the built environment, to minimize distances traveled in the built environment, and so on).

As another non-limiting example, such techniques may be used for determining economic policy. By simulating the actions of groups of humans, the impact of economic policy changes on behavior may be determined, and proper policies may be implemented in order to achieve specific results. Similar benefits may be obtained by using virtual agents to simulate human behavior to determine how humans would react to opening a business of a particular type in a particular location, and an effect that this would have on surrounding businesses.

As yet another non-limiting example, such techniques may be used for developing emergency management plans or simulating epidemic spread. By using virtual agents to simulate the actions of humans, efficient emergency evacuation plans can be developed, community reactions to shelter-at-home or quarantine orders may be determined, and the like. In some embodiments, the actions predicted by the simulation of the virtual agents may be used to determine an automated action to take, including but not limited to an automatic dispatch of buses to transport people during an evacuation, an automatic deployment of a sprinkler or fire suppression system, an automatic lock of a building, an automatic broadcast, display, or other presentation of quarantine- or other public-safety-related messaging, and so on.

As still another non-limiting example, such techniques may be used for automatic generation of content with believable interactions between characters. Instead of having to explicitly code characters to follow particular scripts, each character may be configured with a small set of motivations and a small set of logic that determines what types of action the character is likely to take in response to certain environmental states. Such characters may then be simulated in groups to determine how they interact, and descriptions of the interactions may be used as automatically generated text, audio, and/or video content that is more likely to include believable interactions than if the virtual agents representing the characters did not attempt to infer group membership or goals. Such automatically generated content may be useful in entertainment, educational, or therapeutic settings, among others.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer-implemented method of controlling a first virtual agent, the method comprising:
sensing, by a computing device, an environment, wherein the environment includes one or more environmental states and a group of other virtual agents;
determining, by the computing device, a goal of the group of other virtual agents;
determining, by the computing device, whether the first virtual agent should affiliate with the group of other virtual agents; and
in response to determining that the first virtual agent should affiliate with the group of other virtual agents, changing a goal of the first virtual agent based on the goal of the group of other virtual agents.

2. The computer-implemented method of claim 1, wherein the first virtual agent and the other virtual agents in the group of other virtual agents each represent a non-player character in an interactive computing environment.

3. The computer-implemented method of claim 1, wherein sensing the environment includes:
detecting, by the computing device, one or more environmental states at a first time; and
detecting, by the computing device, changes in the one or more environmental states at a second time.

4. The computer-implemented method of claim 3, wherein determining the goal of the group of other virtual agents includes, for at least one other virtual agent in the group of other virtual agents:
detecting an action taken by the other virtual agent between the first time and the second time; and
inferring an internal state of the other virtual agent based on the action, the one or more environmental states at the first time, and the one or more environmental states at the second time.

5. The computer-implemented method of claim 4, wherein the internal state of the other virtual agent includes whether one or more of the one or more environmental states at the first time are detected by the other virtual agent.

6. The computer-implemented method of claim 4, wherein the internal state of the other virtual agent includes logic implemented by the other virtual agent.

7. The computer-implemented method of claim 4, further comprising determining an archetype for the other virtual agent based on the inferred internal state.

8. The computer-implemented method of claim 1, wherein determining whether the first virtual agent should affiliate with the group of other virtual agents includes comparing a goal of the first virtual agent to the determined goal of the group of other virtual agents.

9. The computer-implemented method of claim 8, wherein comparing the goal of the first virtual agent to the determined goal of the group of other virtual agents includes comparing a time frame for the goal of the first virtual agent to a time frame of the determined goal of the group of other virtual agents.

10. The computer-implemented method of claim 1, wherein changing the goal of the first virtual agent includes adding a new goal for the first virtual agent that matches a goal of at least one of the other virtual agents in the group of other virtual agents or that is a sub-goal of the determined goal of the group of other virtual agents.

11. A non-transitory computer-readable medium having logic stored thereon that, in response to execution by one or more processors of a computing device, cause the computing device to perform actions comprising:
sensing, by the computing device, an environment, wherein the environment includes one or more environmental states and a group of other virtual agents;
determining, by the computing device, a goal of the group of other virtual agents;
determining, by the computing device, whether the first virtual agent should affiliate with the group of other virtual agents; and
in response to determining that the first virtual agent should affiliate with the group of other virtual agents, changing a goal of the first virtual agent based on the goal of the group of other virtual agents.

12. The computer-readable medium of claim 11, wherein the first virtual agent and the other virtual agents in the group of other virtual agents each represent a non-player character in an interactive computing environment.

13. The computer-readable medium of claim 11, wherein sensing the environment includes:
detecting, by the computing device, one or more environmental states at a first time; and
detecting, by the computing device, changes in the one or more environmental states at a second time.

14. The computer-readable medium of claim 13, wherein determining the goal of the group of other virtual agents includes, for at least one other virtual agent in the group of other virtual agents:
detecting an action taken by the other virtual agent between the first time and the second time; and
inferring an internal state of the other virtual agent based on the action, the one or more environmental states at the first time, and the one or more environmental states at the second time.

15. The computer-readable medium of claim 14, wherein the internal state of the other virtual agent includes whether one or more of the one or more environmental states at the first time are detected by the other virtual agent.

16. The computer-readable medium of claim 14, wherein the internal state of the other virtual agent includes logic implemented by the other virtual agent.

17. The computer-readable medium of claim 14, wherein the actions further comprise determining an archetype for the other virtual agent based on the inferred internal state.

18. The computer-readable medium of claim 11, wherein determining whether the first virtual agent should affiliate with the group of other virtual agents includes comparing a goal of the first virtual agent to the determined goal of the group of other virtual agents.

19. The computer-readable medium of claim 18, wherein comparing the goal of the first virtual agent to the determined goal of the group of other virtual agents includes comparing a time frame for the goal of the first virtual agent to a time frame of the determined goal of the group of other virtual agents.

20. The computer-readable medium of claim 11, wherein changing the goal of the first virtual agent includes adding a new goal for the first virtual agent that matches a goal of at least one of the other virtual agents in the group of other virtual agents or that is a sub-goal of the determined goal of the group of other virtual agents.
